(19) United States
(12) Patent Application Publication
(10) Pub. No.: US 2015/0307061 A1
(43) Pub. Date: Oct. 29, 2015

(54) DEVICE FOR RESTRAINING A USER IN A VEHICLE SEAT

(71) Applicant: Anatoly Michailovich CHEKAEV, Moscow (RU)

(72) Inventor: Anatoly Michailovich CHEKAEV, Moscow (RU)

(21) Appl. No.: 14/648,903

(22) PCT Filed: Dec. 4, 2013
(86) PCT No.: PCT/RU2013/001087

§ 371 Date: Jun. 5, 2015

(30) Foreign Application Priority Data
Dec. 7, 2012 (RU) 2012152833

(51) Int. Cl. B60R 22/12; B60R 22/26

(52) U.S. Cl. CPC B60R 22/12; B60R 22/26; B60R 2022/027

(57) ABSTRACT

The present invention relates to means for increasing safety during vehicular transport, specifically for restraining a user in a vehicle seat to avoid injury or death of passengers and drivers of vehicles (automobiles, trains, airplanes, etc.) during collisions or other dangerous situations. The technical result from using the proposed device is the exclusion of interaction between a pelvic restraint and the pubic symphysis of the user's pelvis, thus excluding the possibility of injury to organs located in this area of the user's body, and also a decrease in vertical displacement of the pelvic restraint relative to the pelvis and hips, which leads to an increase in reliability of restraining the pelvis of the user in a given position. The device for restraining a user in a vehicle seat contains a first belt (1), a second belt (2), a third belt (3), a fourth belt (4), a fifth belt (5), a first part of a detachable connection (6), a second part of a detachable connection (7), a first pair of guide elements (8), a second pair of guide elements (9), a third pair of guide elements (10), a fourth pair of guide elements (11), a first pair of connection links (12), a second pair of connection links (13), a third pair of connection links (14), a pad (15), a tensioning means (6), a tensioner (17), a belt-end retainer (5), and a shaft (18).

### BACKGROUND

The invention relates to means for increase of safety while travelling by transport, in particular, for the safety of the user on a vehicle seat to avoid injury or death of passengers and drivers of vehicles (cars, trains, planes, etc.) in case of accidents or in other dangerous situations.

### PRIOR ART

The device for the safety of the user on the vehicle seat including the means for safety of pelvis and thighs, comprising means for safety of the pelvis and means for preventing upward displacement of the pelvis.

(http://win.sabeltspace.com/public/racing.html,Product,Harnesses)

The known device doesn't provide sufficiently reliable retention to the pelvis of the user in a standard position.

### SUMMARY

The technical result from the use of the proposed device is to eliminate the interaction of the means of safety for pelvic with the symphysis pubis by the user, eliminating the possibility of injury to organs located in the area of the user's body, and also to reduce the displacement means for the safety of pelvis upwards in regards to the pelvis and thighs, resulting in improve reliability of the pelvis of the user in a predetermined position.

The specified technical result is reached by the fact that, in the device holding the user on the vehicle seat, includes the means of safety for the pelvis and thighs, containing means of safety for pelvis and means for prevention of upward displacement means of safety for pelvis, means of safety for a pelvis contains means for detachable connection and the first pair of elements of communication connecting its first and second parts according to the first and second elements of a design of the vehicle, the need for changing the position concerning to the vehicle body during its motion is absent, and means for preventing the displacement means for the safety of the pelvis is designed as a second pair coupling elements connecting the first and second portions for detachable connection or corresponding elements of the first pair of elements or with each other, or respectively the third and fourth parts of the vehicle, need for which change of position concerning the vehicle in the course of its movement is absent.

This technical result is achieved by the fact that, the set of means of safety for pelvis and means for preventing displacement by means of safety for the pelvis constitutes the first and second belts connected among themselves and/or lined or with the third and fourth elements of a design of the vehicle, each of which is omitted in series through the respective first and second members of the first pair of directing elements associated respectively with the first and second portions of a releasable connection, directly or through the respective units of the first pair of communication units, and through the first and second members of the second pair of directing elements associated respectively with the first and second structural elements of the transport means directly or through the respective units of the second pair of communication units.

The specified technical result is achieved also by that, the first and second belts are passed consistently through the corresponding directing elements of the first pair of directing elements, the second pair of directing elements, the first pair of directing elements and the third pair of directing elements connecting the first and second belts with the third and fourth elements of a vehicle design directly or through the corresponding links of the third pair of connection units.

The specified technical result is reached also by that the first and second belts are connected with means of a tension.

The specified technical result is reached also by that, the jeans of safety for shoulders is introduced.

This technical result is achieved by the fact that the means for safety of shoulder, comprises passing through the first and second directing elements of the fourth pair of directing elements associated with elements of the vehicle structure, the third strap connected to the first and second parts of the plug connection, either directly or through the corresponding second links a pair of connection units, and means for tensioning the first, second and third belts respectively.

### DETAILED DESCRIPTION

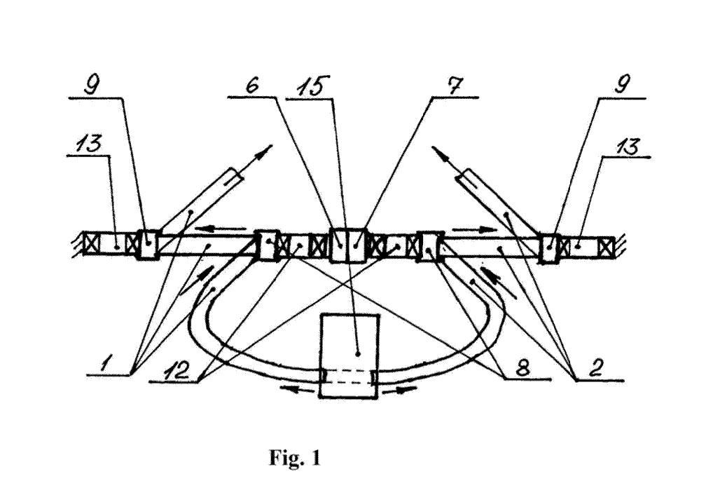

Different variants fort the execution of the safety device for the user on a vehicle seat are represented in FIGS. 1-5.

The safety device for the user on the seat of a vehicle contains the first belt 1, the second belt 2, the third belt 3, the fourth belt 4, a latch of the 5th provision of the end of the belt, the first part of detachable connection 6, the second part of detachable connection 7, the first pair of directing elements 8, the second pair of directing elements 9, the third pair of directing elements 10, the fourth pair of directing elements 11, the first pair of links of communication 12, the second pair of links of communication 13, the third pair of links of communication 14, a lining 15, means of a tension 16, a stretcher 17, a shaft 18.

As a means for detachable connection, consisting of a first part of a detachable connection 6 and the second part of a detachable connection 7, may be applied for locking of aircrafts and automobiles “the four-point” and similar safety belt.

(http://www.schroth.com/tuning/produktdetail.php?id=40&id_kat1=3;

http://www.fmsterwalder-charlv.de/enbuckles-and-strap-adiusting-units.html;

www.amsafe.com,http://www.securon.co.uk/seatbeltsfirstframe.htm;

http://singmay.1uggage-manufacturers.com/product1049642878.html).

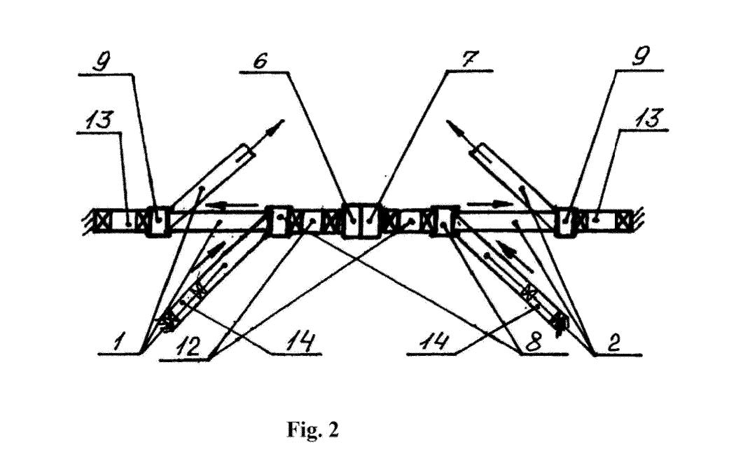

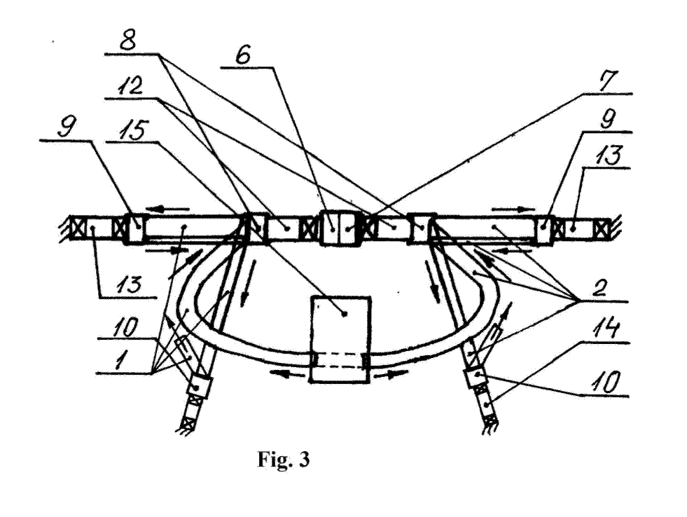

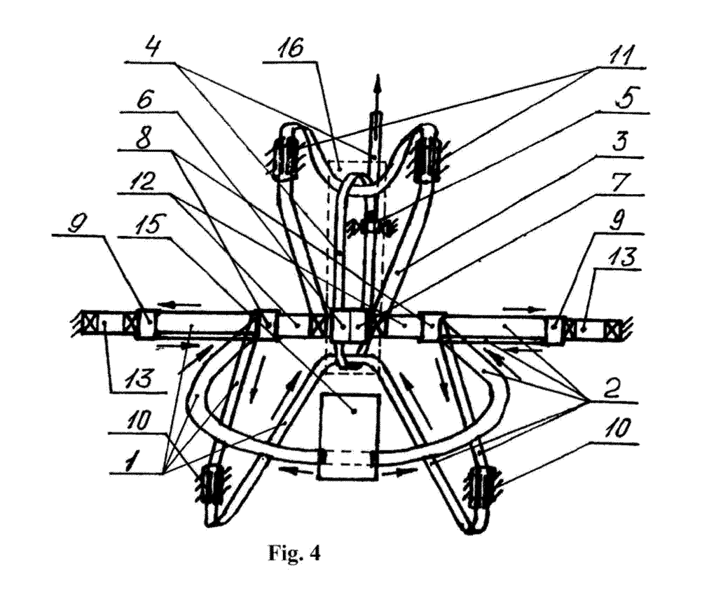

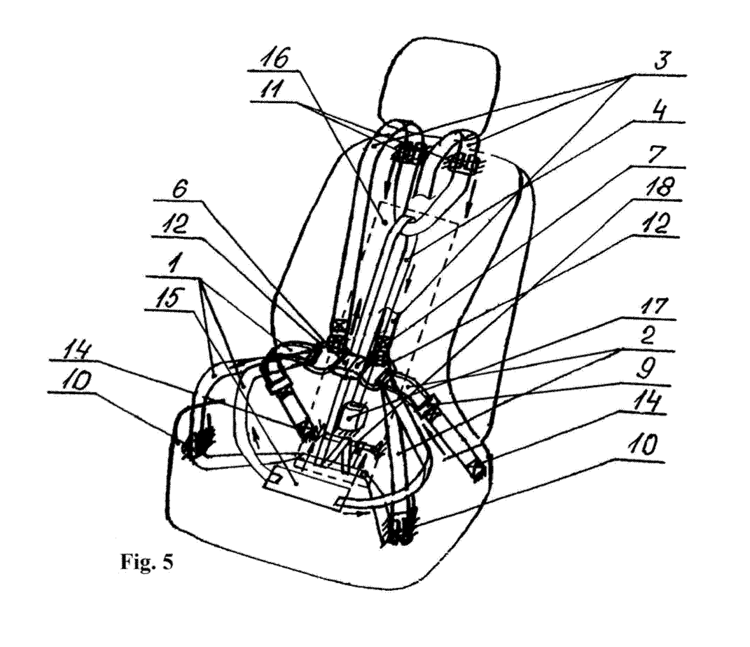

In the implementation of the variants of means of safety for the pelvis and thighs, represented on FIG. 1, FIG. 2 and FIG. 3, and also the options of the device represented on FIG. 4 and FIG. 5, elements of the first pair of directing elements 8 can be executed in the form of a buckle with a fixed crosspiece (for example, HSi700, HSil610; http://www.finsterwalder-charly.de/en/buckles-and-strap-adiusting-units/strap-adiustmg-units.html).

The elements of the second pair of directing elements of 9 variants, means of safety for pelvis and thighs are represented in FIGS. 1 and 2, and also elements of the third pair directing elements 10, are represented on FIG. 3, can be executed in the form of a buckle with a movable crosspiece (for example, HSi80; http://www.finsterwalder-charly.de/en/buckles-and-strap-adiusting-units/strap-adiusting-units.htmn).

The elements of the second pair of directing elements of 9 variants, means for safety of pelvis and thighs are represented in FIG. 3, and also the variants of the device are represented in FIGS. 4 and 5, can be executed in the form of a buckle with a fixed crosspiece (for example HSi700, HSil610; http://www.finsterwalder-charlv.de/en/buckles-and-strap-adjusting-units/strap-adjusting-units.html).

The elements of the third pair of directing elements 10, and the fourth pair of directing elements 11 of the variants of the device are represented in FIG. 4 and FIG. 5, can be executed in the form of the tubular channels directing belts, rings, rollers, their sets, etc. fixed on side parts of a frame of a seat and in the top part of a back of a chair of the user (or executed in them), and providing the necessary direction and the minimum friction of belts on the elements interacting with them.

The communication links constituting the first pair of connection units 12, may be formed as a belt strap segments, rings made of a tape segments and elements equivalent to them providing strong bonds releasably connecting the first part 6 and second part 7 from the ends of the third belt 3 corresponding to them and also with the elements of the first pair of directing elements 8 corresponding to them,

The communication links constituting the second pair of connection units 13 may be configured as segments of the belt strap provided with their corresponding fastening means (e.g. a triangular slotted buckle belt, fastened by an axis on the respective parts of the vehicle, like those shown inhttp://wÂ.schroth.de/Rennsport/Zubehoer/Schrittgurt-Schraubbeschlag/Schrittgurt-I-Schraubbeschlag-Schwarz.htmn), ensuring strong links of each of the second pair of guide elements 9 with the side parts of frame of a seat of a chair of the user.

The communication links constituting the third pair of links 14, communication means for safety of the thighs and pelvis FIG. 2 and FIG. 3 may be formed as segments of the belt strap provided with their corresponding fastening means (e.g. a triangular slotted buckle belt, fastened by an axis or carbine on the respective parts of the vehicle, like those shown in http://vvww.schroth.de/Rennsport/Zubehoer/Schrittgurt-ISchraubbeschlag/Schrittgurt-1-Schraubbeschlag Schwarz.html;http://www.schroth.de/Rermsport/Zubehoer/Einbauset-mit-2-Schraubbeschlaegen.html; http://www.schroth.de/Tuning/Ersatzteile/Endgurt-faer-Rallve-3-Wbite-Tiger/Endgurt-m Rallye-3-White-Tiger-weiss.html), providing strong communication of each of elements of the third pair of directing elements 10 (FIG. 3) with side parts of a frame of a seat of the user.

The lining 15 is a flexible elastic plate, whose link with the first belt 1 prevents displacement of the belt along the hips to the side of the pelvis and provides a standard position of specified belt concerning to the wearer's thighs.

As means of a tension 16 can be applied (carrying out a role of the directing elements fixed on side parts of a frame of a seat of the user) with a movable bridge buckle (e.g., HSi80; http://www.fmstemalder-charly.de/eri/buckles-and-stt̂units.html), through which passed the first belt 1, 2 or second belt and a third belt 3 by pulling the free ends of which arm, for example, can reduce their length and to implement, thus pulling them manually (variants of performance of such means of a tension are represented in FIG. 1, FIG. 2 and FIG. 3).

Also as means of a tension 16 can be applied for tightening slip-loop straps fourth belt 4, one end of which is fixed (for example, on a buckle with a spatially fixed or movable crosspiece fixed element of the vehicle) and the other end or omitted accordingly through the buckle with the movable crosspiece, and it is possible to pull its hand (FIG. 4) or is associated with the tensioner 17, fixed to a vehicle and with pulley block elements if used in the composition polyspast tensioning means 16 (FIG. 5).

As latch 5 can be applied, for example with a movable crosspiece (for example. HSi80 can be applied, for example; httpl://www.finsterwalder-charlv.de/en/buckles-and-strap-adiusting-units/strap-adiusting-units,html. The Hsil500 and HSil50 elements (http://www.fmsterwalder-charly.de/en/buckles-and-strap-adiusting-units/strap-adiusting-units.html) can be applied to reduce friction of the belt on directing the elements, for example or similar to them (tubular elements, etc.: http://www.schroth.de Rennsport/Zubehoer/Schlaufhardware/;′).

While implementing the variants of the device, represented on FIG. 5, as the fourth belt 4 and a the tensioner 17 may be applied corresponding to the three-point safety belt parts, namely, the belt connected to “the retraction mechanism” or “retractor”, represented, for example, on can be applied

http://www.securon.co.uk/seatbeltsfirstframe.htm;

http://www.securon.co.uk/seat_belt_harnesstechspecs.htm;

http://www.securon.co.ukretractors.htm.

During implementation of all the variants of the device, elements of fastening of a belt can be applied, and also means of reduction of friction of belts on the elements of fastening, such as represented on http://www.schroth.de/Rennsport/Zubehoer/Schlauftardware/ScMaufhardware-2-Steg-Schieber-fuer-Gurt.html;http://www.schroth.de/Rennsport/Zubehoer/Einbauset-mit-2-Schraubbeschlaegen.html.

In case of performance of the device with one means of an automatic tension with one tensioner, it is necessary to provide the resultant farce of impact, smaller in size, on means of safety of the pelvis from the shoulder belts, displacing it upward due to their tension, as compared with the strength of the impact on it (on means of safety of the pelvis) from the side of the first belt 1, or the second belt of the 2 and third belt 3 which are a part of means of prevention of upward displacement of the means of safety of the pelvis. Thus continuous safety is provided to the thighs and before braking and retaining body of the user during braking.

In case of performance of the device in variants with use of a manual tension of the hip strap (the first belt 1, and the second belt 2), their sufficient tension, providing continuous safety to the thighs is achieved by using the directing elements (as a part of the second pair of directing elements of the 10 or third pair of directing elements 11) buckles with a mobile cross piece, by means of manual impact on the corresponding belts passing through the specified buckles fixed as appropriate (by means of axes and with application of elements of communication in the form of the pieces of the belts supplied with elements of fastening, executed like shown in http://www.schroth.de/Rennsport/Zubehoer/Schrittgurt-I-Ausklinkbeschlagl:http:// www.schroth.de/Rennsport/Zubehoer/;http://www.schroth.d e/Tuning/Ersatzteile/Endgurt-fuer-Rallve-3-White-Tiger/Endgurt-ruer-Rallye-3-White-Tiger-weiss.htmn on the sides of the user's seat.

The Safety Device is used as Follows:

When using variants of the device with the means for securing the pelvis and thighs as represented in FIG. 1 and FIG. 2, fix the second pair of directing elements 9 by means of elements of the second pair of connection units 13 on side parts of a frame of the seat of the user, and when using variants of the device, with the means for securing the pelvis and thighs as represented in FIG. 3, FIG. 4 and FIG. 5, in addition fix the third pair of directing elements 10 by means of elements of the third pair of communication units 14 also on side parts of a frame of a seat of the user. When using the device with the means of safety for pelvis and thighs as represented in FIG. 2, in addition fix the lower ends of the second belt 2 and third belt 3 by means of elements of the third pair of connection 14 or directly, also on side parts of the frame of the seat of the user.

In all the above cases mentioned above, a fourth pair of directing elements 11 is fixed at the top of the backrest chair of the user on either side of its neck and the liner 15 (FIG. 1, FIG. 3, FIG. 4, FIG. 5) a cushion is placed on the seat of the user.

In the devices represented on FIG. 4 and FIG. 5, the fourth belt 4 which is a part of means of a tension 16, comprise the third belt 3 and a belt formed by connection of the first belt of the 1 and second belt 2 in their middle parts, and or connect one end of the fourth belt 4 with the clamp 5, fixed on vehicle design elements, and pass other end of the fourth belt 4 through a clamp 5 (FIG. 4), or connect one end of the fourth belt 4 with the tensioner fixed on vehicle design elements 17 and in addition several times cover the fourth belt 4 a middle part of the first belt 1 and the shaft 18 fixed by the ends on vehicle design elements, and fix on it the second end of the fourth belt 4 (FIG. 5).

The user accommodates in the chair intended for him, sitting on a seat pillow (FIG. 2), or on the lining lying on a seat pillow 15 (FIG. 1, FIG. 3, FIG. 4, FIG. 5), covering on the shoulders the third belt is placed on the thighs as part of means of safety for the pelvis, and then connects among themselves the first part of means for detachable connection the 6 and second part of means for detachable connection 7.

Devices with the means of safety for pelvis and thighs are represented in FIG. 1, FIG. 2 and FIG. 3, is brought into operation by means of a tension of the belt formed by connection of the first belt of the 1 and second belt 2 (FIG. 1 and FIG. 3), or first belt of the 1 and second belt 2 (FIG. 2) manually, putting the pulling effort to the free ends of the specified belts (it is designated by the arrow leaving the end of a belt). In this the shoulder branch of the third belt 3 is stretched by means of a tension 16, for example, as is shown in FIG. 4 and FIG. 5.

The devices shown in FIG. 4 and FIG. 5, is brought into operation by simultaneous tensioning of all of their constituent belt tensioning means 16 manually (FIG. 4), acting on the free end of the fourth belt 4, either automatically by the fourth belt 4 tension tensioner 17 (FIG. 5).

To bring the device into operation, it is important not only to pull all the straps holding the user, but also provide a downward shift in the thighs by means for securing the pelvis prior to braking and during the whole time of securing the user before the end of braking. Such shift of means of safety for pelvis and thighs is provided in devices with the means of safety for pelvis and thighs is represented in FIG. 1, FIG. 2 and FIG. 3, by placing on the thigh parts holding means for the pelvis and tension the belt arms formed by connecting the first belt 1 and the second belt 2 (FIG. 1 and FIG. 3), either the first belt 1 and the second strap 2 (FIG. 2).

In the devices represented in FIG. 4 and FIG. 5, shift of means of safety for a pelvis down, towards thighs and its safety on thighs will be provided in case the resultant force of the branches of the third belt 3 pulling it up the shoulder and pulling it down (towards hips) the branches of the belt formed by connection of the first belt of the 1 and second belt 2 (which are a part of means for prevention of upward displacement of the means of safety for the pelvis) will have a downward direction and a considerable size. Since the tension force of the belt 3 and the third belt formed by connecting the first belt 1 and the second belt 2 tensioned single loop by means of tension 16 (FIG. 4) are equal and the number of branches of the belt formed by connecting the first belt 1 and the second belt 2, twice the number of branches of the third belt 3, acting on the means of securing the pelvis , considering (not quite vertical) direction of the belt is formed by connecting the first and second belt 1, belt 2, it can be argued that in these devices, the above-described condition is fulfilled with a tension means 16 by a single loop (FIG. 4). However, in such cases where the user can be displaced downwards relative to the pelvis of the seat frame is unlikely (e.g., the seat cushion cannot substantially be pressed during braking) perhaps considerably simplify the device and execute it without covering the thigh of the wearer from below and from the side branch of the belt formed by connecting the first the belt 1 and the second belt 2. In these cases, to substantially increase the tensile force of the belt formed by connecting the first belt 1 and the second belt 2, and excess of the tensile force of the third belt 3 can be applied to the polyspast (pulley) mechanism of the third belt 3 shown in FIG. 5. The action of the mechanism is reduced to cover the specified number of times the tape of the fourth belt 4 of the middle part of the belt formed by connecting the first and second belt 1 belt 2 and mounted on the vehicle structure of the fixed shaft 18. In order to reduce the friction of the fourth belt 4 with their interacting parts, the rollers and elements similar to them made of the corresponding materials can be applied.

In devices with the means of safety for the pelvis and hips represented on FIG. 1, means of safety for pelvis from its upward shift concerning the user's hips covering them from below and from sides of the belt formed by connection of the first belt of the 1 and second belt 2.

In devices with a means for retaining the pelvis and hips, shown in FIG. 2, the means of safety for the pelvis on its upward shift is held relatively to the side parts of the seat frame by the first belt 1 and the second belt 2.

In devices with a means for retaining the pelvis and thighs, shown in FIG. 3, and also in devices of FIG. 4 and FIG. 5, means of safety for the pelvis on its upward displacement is withheld by the branches of the belt formed by connecting the first and second belt 1 belt 2 is relatively user thighs, and with respect to the side portions of the seat frame of the user.

In the event of braking, under the influence of loading held by the user's body, elements of the first pair of directing elements 8 are moved forwardly and downwardly along the belt, the belt formed by connecting the first 1 and second belt 2 (FIG. 1, FIG. 3, FIG, 4, FIG. 5), or along the first belt 1 and the second belt 2 (FIG. 2), and retaining means for the pelvis moves forward and downward and is pressed against the tension forces of the thighs of the specified belts.

In process of braking, the upper body of the user is held by branches of the third belt 3, is displaced forward, and the pelvis of the user comes nearer to vertical situation. The combination of pressing the thighs towards the pelvis and pelvic of the user in an upright position provides reliable safety for the user's pelvic and thighs with an exception of “duck under”.

For reduction of pressure of the first belt 1 and second belt 2 by hips, linings under belts and limiters of shift of elements of the first pair of directing elements 8 in the form of fixed on belts before the directing elements of slips, buckles with a crossing point, etc. can be applied.

Simplification and reduction in cost of the device is reached by application in it the minimum number of belts, a possibility of application of manual means of a tension of belts, or use only one automatic tool.

1. The safety device of the user on the vehicle seat, including the means for keeping the pelvis and the thigh, comprising means for retention of the pelvis and the means for prevention of upward displacement of means for keeping the pelvis differs in that, the means of retention for the pelvis contains tools for detachable connection and the first pair of elements of communication connecting its first and second parts properly with the first and second elements of the structure of the vehicle, the need for changing the position of which relative to the vehicle body during its motion is absent, and means for preventing the displacement means for the retention of the pelvis is designed as a second pair of coupling elements connecting first and second portions for releasable connection means or corresponding elements of the first pair of coupling elements or interconnected or, respectively, the third and fourth parts of the vehicle, the need for changing the position of which relative to the vehicle body in the course of its movement is absent.

2. The safety device of claim 1, characterized in that the set of tools for withholding the pelvis and remedy for preventing upward displacement of the means of containment for the pelvis comprises interconnection between oneself and/or with the lining or with the third and fourth parts of the vehicle first and second belts, each of which passed sequentially through the corresponding first and second pairs of the first pair of guide elements associated respectively with the first and second parts of the plug connection directly or through the corresponding units of the first pair of communication units, and through the first and second members of the second pair of guide elements associated respectively with the first and second structural elements of the vehicle directly or via corresponding links of the second pair of communication units.

3. The safety device of claim 2, characterized in that the first and second belts are passed sequentially through the corresponding directing elements of the first pair of directing elements, the second pair of directing elements, the first pair of directing elements and the third pair of directing elements connecting the first and second belts with the third and fourth elements of a vehicle design directly or through the corresponding links of the third pair of communication links.

5. The safety device of claim 2, characterized in that the first and second belts are connected by means of a tension.

6. The safety device of claim 1, characterized in that the means of withholding of shoulders is introduced.

7. The safety device of claim 1, characterized in that means of retention comprises a shoulder passed respectively through the first and second directing elements of the fourth pair of directing elements, connected with elements of a vehicle, the third strap connected to the first and second parts of detachable connection directly or through the corresponding links of the second pair of communication links, and means of a tension of the first, second and third straps.

8. The safety device of claim 2, characterized in that the means of withholding of shoulders is introduced.

9. The safety device of claim 3, characterized in that the means of withholding of shoulders is introduced.

10. The safety device of claim 4, characterized in that the means of withholding of shoulders is introduced.

11. The safety device of claim 2, characterized in that means of retention comprises a shoulder passed respectively through the first and second directing elements of the fourth pair of directing elements, connected with elements of a vehicle, the third strap connected to the first and second parts of detachable connection directly or through the corresponding links of the second pair of communication links, and means of a tension of the first, second and third straps.

12. The safety device of claim 3 characterized in that means of retention comprises a shoulder passed respectively through the first and second directing elements of the fourth pair of directing elements, connected with elements of a vehicle, the third strap connected to the first and second parts of detachable connection directly or through the corresponding links of the second pair of communication links, and means of a tension of the first, second and third straps.
